(19) United States
(12) Patent Application Publication
(10) Pub. No.: US 2007/0066212 A1
(43) Pub. Date: Mar. 22, 2007

(54) Nozzle array, especially for a motor vehicle

(75) Inventors: Dietrich Klingler, Heubach (DE); Klaus Voigt, Bietigheim-Bissingen (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 10/578,908

(22) PCT Filed: Nov. 10, 2004
(86) PCT No.: PCT/EP04/12717

§ 371 Date: Aug. 15, 2006

(30) Foreign Application Priority Data
Nov. 13, 2003 (DE) 103 53 182.3

(51) Int. Cl. B60H 1/34

(52) U.S. Cl. 454/155

(57) ABSTRACT

The invention relates to a nozzle array (4), especially for a ventilation system of a motor vehicle, comprising a nozzle (1) arranged on one end of the flow channel and a grid (2) arranged in the outlet of the nozzle, wherein the grid (2) covers partly the outlet of the nozzle so that said nozzle (1) is substantially invisible for a passenger.

The invention relates to a nozzle array, especially for a motor vehicle, according to the preamble to claim 1.

From EP 1 223 061 A2, an air discharger, especially for vehicle air conditioning purposes, is, comprising a frame, a plurality of blades, which are disposed pivotably about a first axis, and at least one coupling element, to which each of the blades is coupled, the coupling element being adjustable relative to the first axis between a neutral setting in which the blades are parallel to one another and a comfort setting in which at least part of the blades are pivotable in a mutually opposite direction. The air discharger is disposed in front of an air duct from which there issues an air current, the direction of which can be adjusted with the aid of the air discharger. The air current can here be fanned out with the aid of the counter-pivoted blades, thereby producing a divergent air current in which lower flow velocities prevail than in an air current of constant cross section, so that, even at a high air flow rate, the issuing air current can be prevented from hitting an occupant of the vehicle at high speeds. Such an air discharger still leaves something to be desired, however, especially with regard to the visual appearance.

The object of the invention is to provide an improved nozzle array.

This object is achieved by a nozzle array having the features of claim 1. Advantageous embodiments are the subject of the subclaims.

According to the invention, a nozzle array, especially for a ventilation system of a motor vehicle, is provided, comprising at least one nozzle disposed at one end of a flow duct and a grille disposed at the nozzle outlet, the grille partially, preferably in the central region, concealing the nozzle outlet, so that a gap, especially a gap running around the grille, remains unconcealed. Especially in the case of a purely diffuse air flow, this gap serves for the discharge of air, thereby helping to distribute the air, while a directed air jet can penetrate the grille without difficulty. The grille serves, in particular, as a visual screen, so that the nozzles inside, under normal circumstances, is not or is only barely apparent to a passenger.

Preferably, the grille is rectangular in configuration. In the case of a single nozzle, the grille can then be substantially square in configuration; if two nozzles are disposed side by side, then the grille conceals the central region of both nozzles. The grille in question is preferably a mesh-like grille, which, in particular, is dark, preferably black.

As the nozzle, a swirl nozzle is preferably used, which offers advantages, in particular, when the flow is diffuse.

The invention is explained in detail below on the basis of an illustrative embodiment with reference to the drawing, in which:

FIG. 1 shows a perspective view of a nozzle array according to the illustrative embodiment, the arrows indicating a directed air flow,

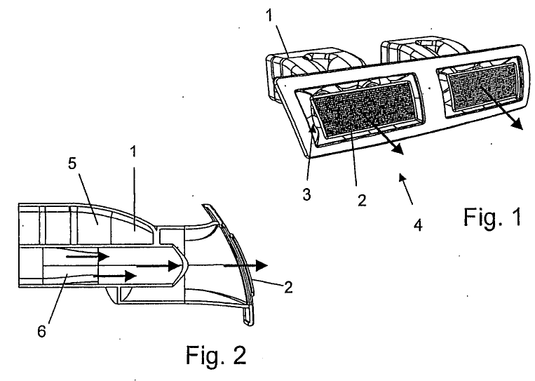

FIG. 2 shows a section through the nozzle array of FIG. 1, the arrows indicating a directed air flow,

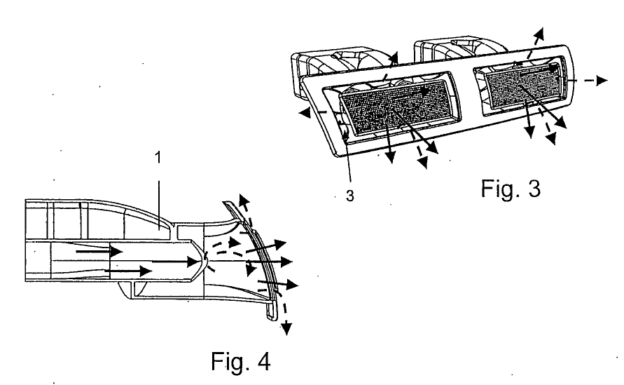

FIG. 3 shows a perspective view of the nozzle array of FIG. 1, the arrows indicating a mixed air flow,

FIG. 4 shows a section through the nozzle array of FIG. 1, the arrows indicating a mixed air flow,

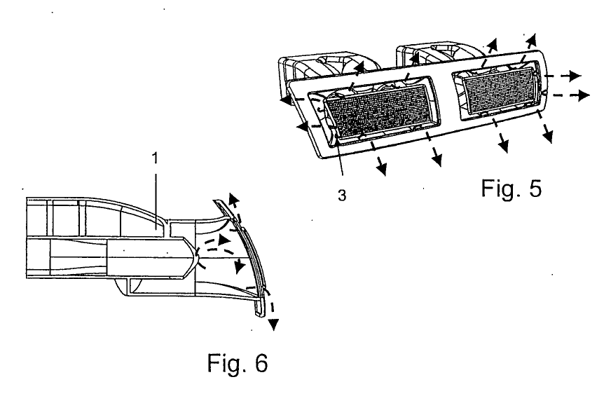

FIG. 5 shows a perspective view of the nozzle array of FIG. 1, the arrows indicating a diffuse air flow, and

FIG. 6 shows a section through the nozzle array of FIG. 1, the arrows indicating a diffuse air flow.

The figures show an adjustable nozzle 1, in the present case a swirl nozzle, which is used in an air discharger of a ventilation system of a motor vehicle. At the end of two adjacent, mutually assigned nozzles 1, hereinafter also referred to as the nozzle outlet, there is disposed a grille 2, integrated in a cover plate, which grille, on the one hand, protects the nozzles 1 and, on the other hand, makes the design more appealing. The grille 2 is here configured such that it conceals the central region of the nozzle outlet, for which purpose it is substantially nontransparent but air-permeable in configuration, yet has a circumferential gap 3. The adjustable nozzles 1 and the grille 2, inclusive of the gap 3, here form a nozzle array 4 according to the invention. In each of FIGS. 1, 3 and 5, two nozzle arrays 4 are represented side by side, as are used, for example in the middle of the dashboard of a motor vehicle.

Each nozzle 1 is supplied, via a flow duct, with temperature-controlled air from an air conditioning system (not represented). This flow duct is divided in the inlet region of each nozzle 1 into two part flow ducts, namely an outer part flow duct 5 and an inner part flow duct 6. The outer part flow duct 5 is here given a swirl by appropriate deviation in the flow path, so that, through this outer part flow duct 5, the vehicle interior is fed air with a diffuse flow path. By contrast, the inner part flow duct 6 is configured as straight as possible, so that, through this part flow duct 6, the vehicle interior is fed air with a relatively uniform, turbulence-free flow.

The outer part flow duct 5 serves, in particular, to supply air in a comfort setting (diffuse flow) to the nozzle array 1 and is rigidly configured, while the inner part flow duct 6 serves to supply the air in a spot setting (directed flow) of the nozzle array 1. Selective mixed settings are possible. The air current supplied through the flow duct is apportioned to the two part flow ducts 5 and 6 by means of a metering device (not represented in greater detail).

If the nozzles 1 are in a spot setting (FIGS. 1 and 2), i.e. a directed air jet is desired, then only air makes its way through the inner part flow duct 6, which air impacts in a swirl-free manner directly upon the central region of the grille 2 and flows through this substantially without diversion. The direction of the air jet can here be adjusted.

If a mixed air flow, i.e. a partially directed and partially diffuse air flow, is desired, as represented in FIGS. 3 and 4, then—in accordance with the desired air discharge—the air is distributed to the outer part flow duct 5 and the inner part flow duct 6, whereby the air jet coming through the inner part flow duct 6 is fanned out by the turbulated air jet flowing through the outer part flow duct 5, so that a fanned-out part air jet is discharged through the grille 2 and a diffuse part air jet through the gap 3.

If only diffuse air is intended to be discharged, then only air makes its way through the outer part flow duct 5, which air, provided with a swirl, makes its way to the nozzle outlet and is discharged, in particular, through the gap 3, whereupon it spreads as far as possible, as indicated by arrows in FIGS. 5 and 6.

### REFERENCE SYMBOL LIST

1 nozzle

2 grille

3 gap

4 nozzle array

5 outer part flow duct

6 inner part flow duct

1. A nozzle array, especially for a ventilation system of a motor vehicle, comprising at least one nozzle disposed at one end of a flow duct and a grille disposed at the nozzle outlet, wherein the grille partially conceals the nozzle outlet.

2. The nozzle array as claimed in claim 1, wherein the grille conceals the nozzle outlet in a central region.

3. The nozzle array as claimed in claim 1, wherein a circumferential gap is provided around the grille.

4. The nozzle array as claimed in claim 1, wherein the grille is rectangular in configuration.

5. The nozzle array as claimed in claim 1, wherein the grille is substantially nontransparent in configuration.

6. The nozzle array as claimed in claim 1, wherein the grille is mesh-like in configuration.

7. The nozzle array as claimed in one claim 1, wherein the nozzle is a swirl nozzle.

8. The nozzle array as claimed in claim 1, wherein two nozzles are disposed side by side, which are jointly concealed by the grille.

9. The nozzle array as claimed in claim 1, wherein the grille, at the left and/or right ends, is semicircular in configuration.

10. A ventilation system, especially for a motor vehicle, wherein at least one nozzle array as claimed in claim 1.
